(19) United States
(12) Patent Application Publication
(10) Pub. No.: US 2011/0316908 A1
(43) Pub. Date: Dec. 29, 2011

(54) PRINTER AND PRINTING METHOD

(75) Inventor: Akira Miyagawa, Shiojiri-shi (JP)

(73) Assignee: SEIKO EPSON CORPORATION, Shinjuku-ku (JP)

(21) Appl. No.: 13/168,344

(22) Filed: Jun. 24, 2011

(30) Foreign Application Priority Data
Jun. 24, 2010 (JP) 2010-143958

(51) Int. Cl. B41J 2/195

(52) U.S. Cl. 347/7

(57) ABSTRACT

A printer has a thermal print unit that prints by heating a thermochromic medium, an inkjet print unit that prints on the thermochromic medium, a remaining ink detection unit that detects the remaining ink level of the inkjet print unit, a halftone processing unit that converts acquired print data to thermal print data and inkjet print data, and a control unit that controls the thermal print unit and inkjet print unit based on the thermal print data and inkjet print data. The control unit causes the thermal print unit to print the inkjet print data when the detected remaining ink level is less than the amount of ink required to print the acquired inkjet print data.

### BACKGROUND

1. Technical Field

The present invention relates to a printer. More specifically, the invention relates to a printer and a printing method that can use both thermal and inkjet printing methods to print on thermochromic roll paper.

2. Related Art

Compact printers are commonly used together with a cash register in retail stores to print and issue sales receipts containing transaction information for purchased products. Such printers are also used to print store logos, product advertisements, promotional information for sale campaigns, and other types of marketing messages together with the transaction information in order to promote sales. Such marketing messages may be printed in open space above or below the transaction information, or even on the back of the receipt, for example.

Two methods are typically used to print and present such marketing messages on receipts to customers. One method is to load the printer with roll paper having specific marketing messages preprinted on the back side, for example. Because the marketing message can be preprinted on the roll paper, this method enables color printing and even printing photographs, for example, on receipts. However, regularly changing the content of the printed marketing message, and printing different content for different stores, are difficult with this method.

Another method of printing marketing messages on receipts uses the same print mechanism used to print the transaction information, or uses a separate, dedicated print mechanism, to print marketing messages on receipts at the point of sale. This method enables changing the marketing message data stored in the printer as necessary, and easily printing marketing messages with different content in different stores.

See, for example, Japanese Unexamined Patent Appl. Pub. JP-A-2003-170631.

However, if an inkjet print mechanism for printing color marketing messages is provided separately to the print mechanism for printing transaction information, receipt printing is interrupted when the inkjet print mechanism runs out of ink, and printing cannot resume until the operator replenishes the ink supply. A function that stops printing marketing messages using the inkjet print mechanism when the ink runs out and switches to printing only transaction information using a transaction print mechanism is also conceivable. However, if the cash register operator forgets or puts off adding ink when this happens, customers making purchases at that register will not be able to receive the coupons, special information, or other marketing message.

### SUMMARY

A first aspect of the invention is a printer including: a thermal print unit that prints by contacting and heating a surface of a thermochromic medium; an inkjet print unit that prints by ejecting ink onto the surface of the thermochromic medium; a remaining ink detection unit that detects a remaining ink level of the inkjet print unit; a halftone processing unit that converts acquired print data to thermal print data for printing by the thermal print unit and inkjet print data for printing by the inkjet print unit; and a control unit that controls printing operations of the thermal print unit and inkjet print unit based on the thermal print data and inkjet print data, and causes the thermal print unit to print according to the inkjet print data when the detected remaining ink level is less than the amount of ink required to print according to the acquired inkjet print data.

When a thermal print unit prints price and other transaction information on thermal receipt and an inkjet print unit prints logos and marketing messages, a printer according to this aspect of the invention can prevent interrupting the printing operation when ink runs out because at least part of the inkjet print data can be printed by the thermal print unit when there is not enough ink left to print the logo or marketing message by inkjet printing.

In a printer according to another aspect of the invention, the control unit preferably causes the thermal print unit to print the remaining print data units when the read inkjet print data consists of a plurality of print data units and the remaining amount of ink is less than the amount of ink required to print the remaining print data units to be printed.

This aspect of the invention determines whether to change to thermal printing due to a lack of ink before printing each logo, advertisement, or other data unit (print data unit) with the inkjet print unit. Ink will therefore not run out while printing a logo, text, graphic, or other object with the inkjet print unit, and the appearance of the final printout is therefore good.

Further preferably in another aspect of the invention, the printer also has a resistance detection unit that detects the electrical resistance of a heating unit that heats the surface of the thermochromic medium in the thermal print unit. When the detected remaining ink level exceeds the amount of ink required to print the read inkjet print data, and the detected electrical resistance exceeds a preset control limit, the control unit causes the inkjet print unit to print at least part of the thermal print data.

If the thermal head fails and thermal printing is disabled, this aspect of the invention can switch to inkjet printing at least part of the data intended to be thermally printed, and interruption of the printing operation due to a thermal head failure can therefore be prevented.

Another aspect of the invention is a printing method including: a thermal print step that prints by contacting and heating a surface of a thermochromic medium; an inkjet print step that prints by ejecting ink onto the surface of the thermochromic medium; a remaining ink detection step that detects a remaining ink level for printing in the inkjet print step; a halftone processing step that converts acquired print data to thermal print data for printing in the thermal print step and inkjet print data for printing in the inkjet print step; and a printing means switching step that that causes printing according to the inkjet print data to be executed in the thermal print step when the remaining ink level detected in the remaining ink detection step is less than the amount of ink required to print according to the inkjet print data.

Preferably, when the read inkjet print data consists of a plurality of print data units and the remaining amount of ink detected in the remaining detection step is less than the amount of ink required to print the remaining print data units to be printed, the printing means switching step prints the remaining print data units in the thermal print step.

Further preferably, the printing method also has a resistance detection step that detects the electrical resistance of a heating unit used to heat the surface of the thermochromic medium in the thermal print step; and when the detected remaining ink level exceeds the amount of ink required to print the read inkjet print data, and the detected electrical resistance exceeds a preset control limit, the printing means switching step prints at least part of the thermal print data in the inkjet print step.

The foregoing summary of the invention does not list all required features of the invention, and subcombinations of these feature groups are also included in the scope of the invention.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 shows the configuration of a printer 100 according to a preferred embodiment of the invention, and a host computer 200 that sends control commands to the printer 100.

FIG. 2 shows an example of a receipt on which transaction information and marketing message are printed on roll paper by the printer 100.

FIG. 3 is a flow chart showing the operation of the printer 100 when printing on roll paper.

FIG. 4 continues the flow chart showing the operation of the printer 100 when printing on roll paper.

### DESCRIPTION OF EMBODIMENTS

A preferred embodiment of the present invention is described below with reference to the accompanying figures, but the scope of the accompanying claims is not limited to the following embodiment and all of the featured elements described below are not required for the solution provided by the invention.

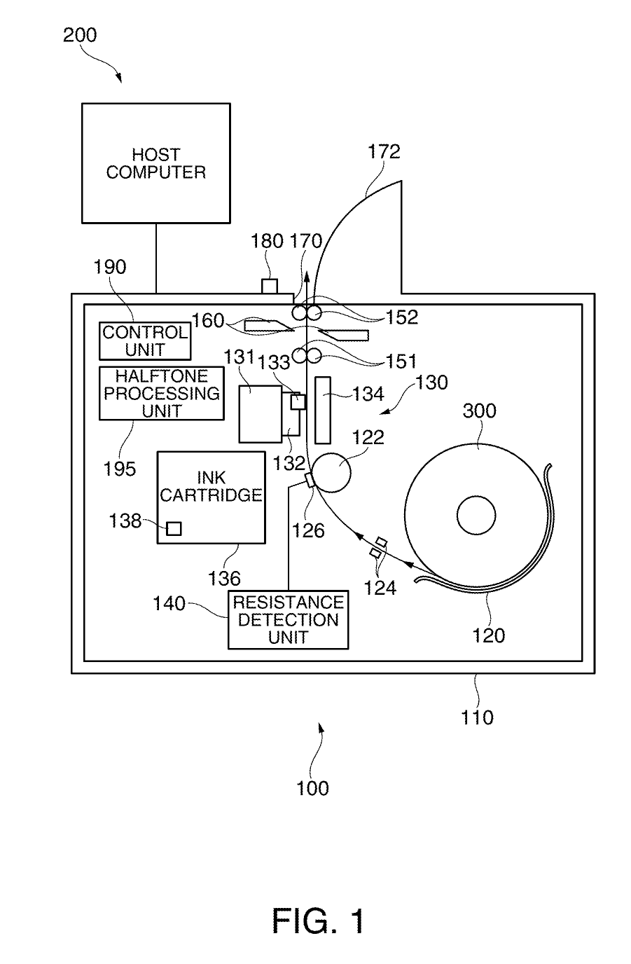

FIG. 1 schematically describes a printer 100 according to this embodiment of the invention and the host computer 200 that sends control commands to the printer 100. As shown in FIG. 1, the printer 100 includes a roll paper storage unit 120, paper feed roller 122, roll paper sensor 124, thermal print unit 126, inkjet print unit 130, resistance detection unit 140, paper discharge mechanism 150, paper cutter mechanism 160, control unit 190, and halftone processing unit 195 disposed inside an external case 110. A paper exit 170, stacker 172, and warning indicator LED 180 are disposed at the top of the case 110.

The roll paper storage unit 120 stores thermochromic roll paper. The leading end of the roll paper is pulled through a specific transportation path by the paper feed roller 122 and conveyed to the paper exit 170. The roll paper sensor 124 detects if roll paper is in the transportation path.

The inkjet print unit 130 includes a carriage 131, inkjet head 132, ink ejection sensor 133, platen 134, ink cartridge 136, and remaining ink sensor 138. The inkjet print unit 130 prints on the roll paper by moving the carriage 131 perpendicularly to the roll paper transportation direction while ejecting ink supplied from the ink cartridge 136 onto the surface of the roll paper from the inkjet head 132 based on print data (inkjet print data) and a print control command from the control unit 190.

The remaining ink sensor 138 is an example of a remaining ink detection unit according to the invention.

Ink that is discharged from the inkjet head but is not used for printing is recovered by the platen 134. The remaining ink level in the ink cartridge 136 is periodically checked by the remaining ink sensor 138. The ejection state of ink discharged from the inkjet head 132 is also checked by the ink ejection sensor 133. The inkjet print unit 130 in this embodiment of the invention can be used for color printing using plural colors of ink (such as cyan, magenta, yellow, and black).

The thermal print unit 126 has a thermal printhead that contacts and heats the surface of the roll paper so that the surface of the paper changes color only in the areas to be printed. The thermal print unit 126 also prints transaction information such as product prices and quantities on the roll paper surface based on print data (thermal print data) and a print control command from the control unit 190.

The paper discharge mechanism 150 is disposed on the paper exit 170 side of the inkjet print unit 130, and has discharge rollers 151, 152 disposed with the paper cutter mechanism 160 therebetween. The discharge rollers 151, 152 discharge roll paper that has passed the inkjet print unit 130 from the paper exit 170 to the outside of the printer.

The paper cutter mechanism 160 includes a fixed knife and a movable knife, and cuts the roll paper discharged by the paper discharge mechanism 150 between the fixed knife and movable knife to a specific length. The roll paper cut by the paper cutter mechanism 160 is discharged by discharge rollers 152 from the paper exit 170 to the outside and deposited onto the stacker 172, and can be easily picked up.

If a stacker 172 is not provided outside the printer 100, the paper cutter mechanism 160 may only partially cut the roll paper discharged by the paper discharge mechanism 150 instead of cutting the paper completely. Because the discharged roll paper thus remains attached to the remaining roll paper in this case, the discharged roll paper is not easily lost and can be easily severed from the remaining roll paper.

The discharge rollers 152 are disposed near the paper exit 170 in this embodiment of the invention. As a result, when a stacker 172 such as described above is not provided, the trailing end of the roll paper (receipt) that is cut by the paper cutter mechanism 160 can remain held between the discharge rollers 152 while the largest part of the receipt is held exposed outside the paper exit 170, and the receipt can therefore be easily removed. The receipt is also not easily lost in this case because the receipt does not separate completely from the printer 100 (because the trailing end is held by the discharge rollers 152).

When the roll paper sensor 124 detects that the roll paper stored in the roll paper storage unit 120 has run out, or the remaining ink sensor 138 detects that the remaining ink level in the ink cartridge 136 is below a certain level, for example, the warning indicator LED 180 lights in a particular color or mode according to the particular condition. Note that the method of displaying a warning is not limited to using an LED 180 as a warning indicator, and other methods such as displaying warning messages using an LCD disposed on the outside of the case 110 are also conceivable.

The halftone processing unit 195 acquires image data sent from a host computer 200 used in the cash register, for example, and converts the image data to thermal print data for thermal printing by the thermal print unit 126 and inkjet print data for inkjet printing by the inkjet print unit 130. The halftone processing unit 195 outputs the converted thermal print data and inkjet print data to the control unit 190.

The control unit 190 is rendered by a processor and buffer memory, for example, receives and stores thermal print data and inkjet print data output from the halftone processing unit 195 in buffer memory. The control unit 190 also receives print commands sent from the host computer 200, and outputs control commands to other parts of the printer 100 according to the content of the print command.

More specifically, when a print command is sent with image data describing the content to be printed on roll paper from the host computer 200, the control unit 190 controls the following operations. First, the thermal print data and inkjet print data converted from the received print data is acquired from the halftone processing unit 195. The thermal print unit 126 then thermally prints the transaction information on roll paper according to the print command from the host computer 200. The control unit 190 then drives the paper feed roller 122 to convey the roll paper on which the transaction information was printed to the printing position of the inkjet print unit 130. The inkjet print unit 130 then inkjet prints a logo and marketing message on the roll paper. The paper discharge mechanism 150 is then driven to discharge the printed roll paper outside the printer from the paper exit 170.

The control unit 190 receives detection results from the roll paper sensor 124, and the ink ejection sensor 133 and remaining ink sensor 138 of the inkjet print unit 130, and changes the control commands accordingly. For example, if the remaining ink level detected by the remaining ink sensor 138 is below the ink level required to inkjet print the data to be printed, the control unit 190 drives the thermal print unit 126 to print the data that should be printed by the inkjet print unit 130.

The printer 100 according to this embodiment of the invention can therefore switch to thermally printing content that is intended to be printed by inkjet when the amount of ink left in the ink cartridge 136 is too low to print the logo and marketing message. As a result, the printer 100 will not stop printing when it runs out of ink.

The control unit 190 determines whether or not there is enough ink left in the ink cartridge 136 before the printing operation of the inkjet print unit 130 starts, for example. More specifically, the control unit 190 checks the remaining ink level of the ink cartridge 136 before starting to print with the inkjet print unit 130. If the remaining ink level is confirmed to be less than the amount of link required to inkjet print the scheduled logo and marketing message in their entirety, the control unit 190 prints the content to be printed by the inkjet print unit 130 with the thermal print unit 126.

The control unit 190 may also send these detection results and the status of the thermal print unit 126 and inkjet print unit 130 printing operations to the host computer 200.

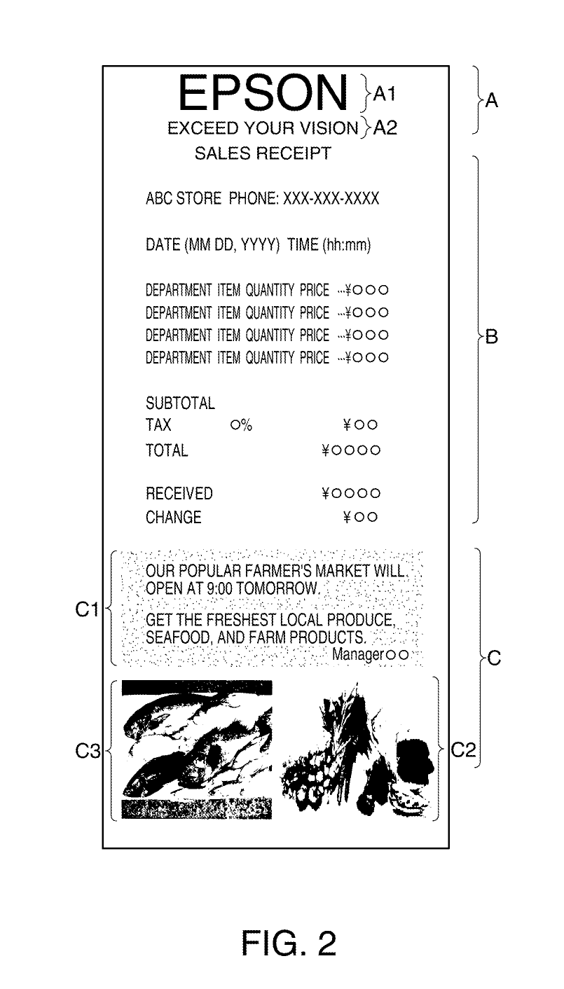

FIG. 2 shows an example of a receipt having transaction information and a marketing message printed on roll paper by the printer 100. In this example the logo shown in block A on the receipt in FIG. 2 is printed in color by the inkjet print unit 130. The marketing message printed in block C in FIG. 2 is likewise printed in color by the inkjet print unit 130. The transaction information including purchased items and price information is thermally printed by the thermal print unit 126 in block B in FIG. 2.

When inkjet print data consisting of plural print data units is printed by the inkjet print unit 130, the control unit 190 may alternatively determine if the amount of ink left in the ink cartridge 136 is sufficient to print the next print data unit each time inkjet printing each print data unit is completed. Using the receipt shown in FIG. 2 for example, the inkjet print data for the logo printed on the receipt consists of the print data unit corresponding to block A1 in FIG. 2, and the print data unit corresponding to block A2 in FIG. 2. The inkjet print data of the marketing message to be printed on the receipt similarly consists of the print data units shown in blocks C1, C2, and C3 in FIG. 2.

When the inkjet print data consists of plural print data units as described above, the control unit 190 outputs a signal indicating that printing a print data unit was completed to the inkjet print unit 130 each time the inkjet print unit 130 finishes printing a print data unit, and acquires the remaining ink level detected in the ink cartridge 136. The control unit 190 then determines if the detected ink level exceeds the amount of ink required to print the next print data unit to be printed.

For example, if the remaining ink in the ink cartridge 136 is less than the amount of ink required to print block A2 in FIG. 2 when the inkjet print unit 130 finishes printing block A1 in FIG. 2, the control unit 190 changes printing blocks A2, C1, C2, C3 in FIG. 2 to thermal printing by the thermal print unit 126.

By thus checking the remaining ink level and switching to thermal printing as necessary after each print data unit is printed, the ink will not run out while the inkjet print unit 130 is in the middle of printing a logo, text, or graphic, and the appearance of the final printout is improved.

The thermal print unit 126 in a printer 100 according to this embodiment of the invention has a heating unit (thermal head) with a specific resistance, and thermally prints by heating the surface of a thermochromic medium. The printer 100 also has a resistance detection unit 140 that detects the electrical resistance of the heating unit and outputs the result to the control unit 190. If the detected electrical resistance exceeds a predefined upper limit, the control unit 190 changes printing the unprinted part of the data to be thermally printed by the thermal print unit 126 to inkjet printing by means of the inkjet print unit 130. That the remaining ink level in the ink cartridge 136 exceeds the amount of ink required to print the inkjet print data could be defined as a condition for changing to inkjet printing.

As a result, when the thermal head fails and thermal printing is not possible, the printer 100 according to this embodiment of the invention can switch printing at least part of the thermal print data to inkjet printing. Interruption of the printing operation due to a thermal head failure can therefore be prevented.

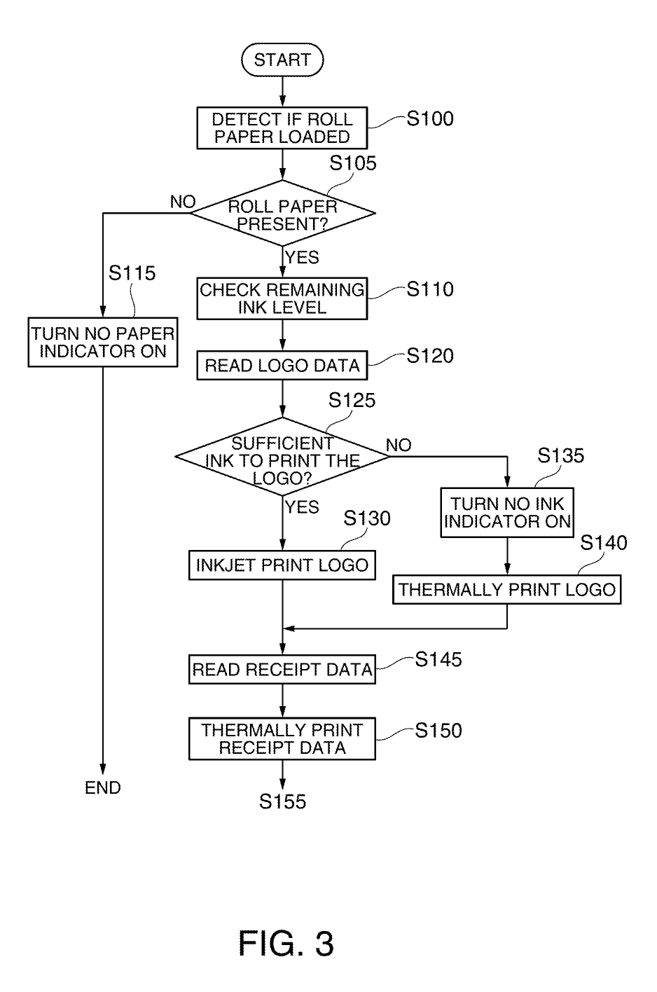

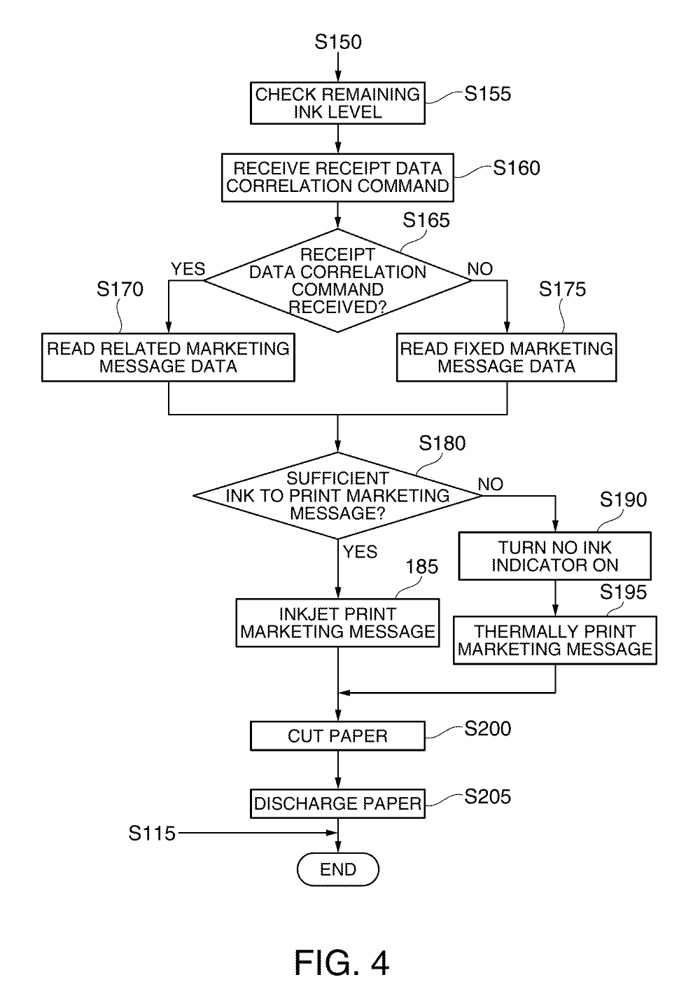

FIG. 3 and FIG. 4 show a flow chart describing roll paper printing by means of this printer 100.

This operation starts by the roll paper sensor 124 detecting whether or not roll paper is present (step S100). If the roll paper sensor 124 does not detect roll paper because, for example, the roll paper stored in the roll paper storage unit 120 ran out (step S105 returns No), the control unit 190 causes the warning indicator LED 180 to light in the mode indicating that roll paper must be loaded (step S115).

When roll paper is detected (step S105 returns Yes), the control unit 190 gets detection data for the remaining ink in the ink cartridge 136 from the remaining ink sensor 138 of the inkjet print unit 130 (step S110). The control unit 190 then reads the inkjet print data that was generated by the halftone processing unit 195 for the logo to be printed on the roll paper (step S120).

If the ink remaining in the ink cartridge 136 exceeds the amount of ink required to inkjet print the logo (step S125 returns Yes), the control unit 190 inkjet prints the logo by means of the inkjet print unit 130 according to the print command from the host computer 200 (step S130). If the ink remaining in the ink cartridge 136 is less than the amount of ink required to inkjet print the logo (step S125 returns No), the control unit 190 causes the warning indicator LED 180 to light in the mode indicating that the remaining ink level is less than the alarm level (step S135).

After then driving the paper feed roller 122 to convey the area where the logo is to be printed on the roll paper to the printing position of the thermal print unit 126, the control unit 190 drives the thermal print unit 126 to thermally print the logo according to the print command from the host computer 200 (step S140).

The control unit 190 then reads the thermal print data including the transaction information (receipt data) to be printed on the roll paper generated by the halftone processing unit 195 (step S145). The content of the thermal print data is then thermally printed by the thermal print unit 126 according to the print command from the host computer 200 (step S150).

The control unit 190 then acquires detection data for the remaining ink in the ink cartridge 136 from the remaining ink sensor 138 of the inkjet print unit 130 (step S155). The control unit 190 then receives a command for printing a marketing message (related marketing message) that is related to the receipt data printed on the roll paper from the host computer 200 (step S160).

When this command is received from the host computer 200 (step S165 returns Yes), the control unit 190 reads the inkjet print data generated by the halftone processing unit 195 for the related marketing message to be printed on the roll paper (step S170). If the control unit 190 does not receive this command from the host computer 200 (step S165 returns No), the control unit 190 reads a fixed marketing message from buffer memory (step S175).

Based on the remaining ink detection data acquired in step S155, the control unit 190 determines if the amount of ink remaining in the ink cartridge 136 is greater than the amount of ink needed to inkjet print the related marketing message or fixed marketing message (step S180).

If the ink remaining in the ink cartridge 136 exceeds the amount of ink required to inkjet print the related marketing message or the fixed marketing message (step S180 returns Yes), the control unit 190 inkjet prints the related marketing message or the fixed marketing message by means of the inkjet print unit 130 according to the print command from the host computer 200 (step S185).

If the ink remaining in the ink cartridge 136 is less than the amount of ink required to inkjet print the related marketing message or the fixed marketing message (step S180 returns No), the control unit 190 causes the warning indicator LED 180 to light in the mode indicating that the remaining ink level is less than the alarm level (step S190).

The control unit 190 then drives the paper feed roller 122 to convey the area where the related marketing message or the fixed marketing message is to be printed on the roll paper to the thermal print unit 126. The related marketing message or the fixed marketing message is then printed by the thermal print unit 126 according to a print command from the host computer 200 (step S195).

When the inkjet print unit 130 finishes printing the marketing message on the roll paper, the roll paper is cut to a specific length by the paper cutter mechanism 160 (step S200), and is discharged outside the printer from the paper exit 170 by the paper discharge mechanism 150 (step S205). The operation shown in this flow chart thus ends.

In addition to thermally printing transaction information including price information on thermochromic roll paper and color printing logos and marketing messages on the same roll paper, a printer 100 according to this embodiment of the invention can switch to thermally printing content intended for inkjet printing where there is not enough ink left in the ink cartridge 136 for inkjet printing the logo or marketing message. The printing operation of the printer 100 will therefore not be interrupted when the ink runs out.

The invention is described above using a preferred embodiment thereof by way of example, but the scope of the invention is not limited to the foregoing embodiment and many changes and improvements will be obvious to one with ordinary skill in the related art.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

1. A printer comprising:
a thermal print unit that prints by contacting and heating a surface of a thermochromic medium;
an inkjet print unit that prints by ejecting ink onto the surface of the thermochromic medium;
a remaining ink detection unit that detects a remaining ink level of the inkjet print unit;
a halftone processing unit that converts acquired print data to thermal print data for printing by the thermal print unit and inkjet print data for printing by the inkjet print unit; and
a control unit that controls printing operations of the thermal print unit and inkjet print unit based on the thermal print data and inkjet print data, and causes the thermal print unit to print according to the inkjet print data when the detected remaining ink level is less than the amount of ink required to print according to the acquired inkjet print data.

2. The printer described in claim 1, wherein:
when the read inkjet print data consists of a plurality of print data units and the remaining amount of ink is less than the amount of ink required to print the remaining print data units to be printed, the control unit causes the thermal print unit to print the remaining print data units.

3. The printer described in claim 1, further comprising:
a resistance detection unit that detects the electrical resistance of a heating unit that heats the surface of the thermochromic medium in the thermal print unit; and
when the detected remaining ink level exceeds the amount of ink required to print the read inkjet print data, and the detected electrical resistance exceeds a preset control limit, the control unit causes the inkjet print unit to print at least part of the thermal print data.

4. A printing method comprising:
a thermal print step that prints by contacting and heating a surface of a thermochromic medium;
an inkjet print step that prints by ejecting ink onto the surface of the thermochromic medium;
a remaining ink detection step that detects a remaining ink level for printing in the inkjet print step;
a halftone processing step that converts acquired print data to thermal print data for printing in the thermal print step and inkjet print data for printing in the inkjet print step; and
a printing means switching step that that causes printing according to the inkjet print data to be executed in the thermal print step when the remaining ink level detected in the remaining ink detection step is less than the amount of ink required to print according to the inkjet print data.

5. The printing method described in claim 4, wherein:
when the read inkjet print data consists of a plurality of print data units and the remaining amount of ink detected in the remaining detection step is less than the amount of ink required to print the remaining print data units to be printed, the printing means switching step prints the remaining print data units in the thermal print step.

6. The printing method described in claim 5, further comprising:
a resistance detection step that detects the electrical resistance of a heating unit used to heat the surface of the thermochromic medium in the thermal print step; and
when the detected remaining ink level exceeds the amount of ink required to print the read inkjet print data, and the detected electrical resistance exceeds a preset control limit, the printing means switching step prints at least part of the thermal print data in the inkjet print step.
